(19) United States
(12) Patent Application Publication
(10) Pub. No.: US 2004/0103034 A1
(43) Pub. Date: May 27, 2004

(54) RFID system and method for purchase item accountability

(75) Inventors: Walter C. Reade, Appleton, WI (US); Jeff Lindsay, Appleton, WI (US)

Correspondence Address: STEPHEN E. BONDURA, ESQ., DORITY & MANNING, P.A., P.O. BOX 1449, GREENVILLE, SC, 29602-1449, US

(73) Assignee: KIMBERLY-CLARK WORLDWIDE, INC.

(21) Appl. No.: 10/301,882

(22) Filed: Nov. 21, 2002

(51) Int. Cl. G06F 17/60

(52) U.S. Cl. 705/16

(57) ABSTRACT

A RFID method and system are provided for aiding consumers in the selection or purchase of products according to a predetermined list of such products. RFID smart tags are associated with products in a place of purchase or selection of such products. Each distinct product is associated with at least one smart tag, the smart tags containing identification information regarding their respective product. The list of desired products is entered into a RFID scanner and selected products are scanned with the scanner. The retrieved product identification information is used to automatically annotate the displayed list of desired products.

### TECHNICAL FIELD OF THE INVENTION

The present invention relates to a system and method for ensuring accountability of purchase items with a predetermined list of such items.

### BACKGROUND

Radio Frequency Identification Devices (RFIDs) are low-cost, passive “smart” chips or “tags” that can be embedded in or attached to articles, products, and the like to convey information about the product via a scanner. The smart tags are generally small label-like devices with a micro-chip and a miniature embedded antennae. The tags may be passive or active, the active tags requiring an internal power supply. A reader or scanner interrogates the smart tag with an electronic “trigger” signal. The tag in turn generates an electromagnetic pulse response that is readable by the scanner, the response containing the product information. RFID smart tags can be embedded in or attached to product packaging, or incorporated directly into the product, and may convey conventional “bar code” information, as well as other more detailed information.

Various commercial applications have been suggested for smart tags, particularly in the area of retail marketing and sales. For example, RFID technology may be used to gather information related to consumer trends, purchasing habits, consumption rates, etc. It has also been suggested that RFID technology has promise in the areas of inventory control, manufacturing process and control, product accountability and tracking systems, etc. Manufacturers, shippers, and retailers may be able to follow a given product through their respective systems from initial production through to point of sale. It has been suggested that other applications may include shopping carts that automatically charge a bank account, refrigerators that tap into the Internet to automatically reorder items that are running low, and interactive televisions linked to such refrigerators that will feed targeted commercials and special offers to consumers. (See, “They Know What You Eat,” by Kayte VanScoy, Smart Business, January 2001).

The present invention relates to a novel implementation of RFID technology to aid consumers or any individual desiring to purchase items previously listed or otherwise identified.

Consumers are constantly faced with the task of keeping track of products or items that have been depleted and, thus, must be subsequently repurchased. A common scenario is the “food shopping list” wherein a homemaker keeps a running list of food items that have been depleted. This scenario, however, is not limited to food items, but pertains equally to any manner of consumer goods. At some point, the consumer typically takes the list to the market and attempts to find and purchase the necessary items. The “list” may be in paper form, or entered electronically in a portable device, such as a PDA (Personal Data Assistant).

Unfortunately, it is an all too common experience for the list of necessary items to become lost or destroyed. In this case, the consumer is faced with the task of trying to recreate the items on the list.

Even if the consumer has the list at the market or place of purchase of the items, the task of ensuring that all of the listed items are in fact purchased can be problematic, particularly if the list of items is extensive. With a paper list, or even an electronically displayed list, each item must be individually “checked-off” as the item is retrieved and, for example, placed in a basket or cart. Unfortunately, the items are not presented in the market or store in the order in which a consumer has them listed. An item at the bottom or middle of the list may be found and retrieved prior to an item at the top of the list, and so forth. Also, in the case of a paper list, a writing instrument must be kept handy to make a visible annotation that the item has been retrieved. With an electronic list, a data entry must be made to indicate that a listed item has been retrieved. Any mother or homemaker attempting to shop for and purchase food items from an extensive shopping list in the presence of young children can attest to the inherent inconveniences with such traditional methods. For example, young children are notorious for placing unnecessary or unwanted items into a shopping cart, or taking necessary items out of a shopping cart, unbeknownst to the accompanying adult.

The present invention relates to a novel implementation of RFID technology to aid consumers in the purchasing of items according to a predetermined or a defined list.

### SUMMARY

Objects and advantages of the invention will be set forth in the following description, or may be obvious from the description, or may be learned through practice of the invention.

A methodology and system according to the invention involves, in general aspects, the incorporation of RFID smart tags with products at a place of purchase or selection of products according to a pre-defined list of desired products. The smart tags are coded with product identification information, such as the name of the product, type or category of product, manufacturer of the product, and so forth. Smart tag scanners/receivers are made available to consumers in a number of conceivable scenarios according to the invention. The scanners are configured to accept a downloaded electronic list of desired products and display the list to the consumer. The scanner scans the smart tags associated with the products selected by the consumer and, if the selected product is on the list of desired products, the scanner automatically “checks-off” the product on the displayed list in a manner such that it is clear to the consumer that the product is accounted for.

In one particular embodiment of the system and methodology according to the invention, the smart tags are attached to each individual product at the place of purchase or selection. For example, the smart tags may be in the form of adhesive labels or the like that are attached to the product packaging. In this case, the individual products are individually scanned by the scanner (or a component of the scanner, which can include a plurality of cooperatively associated electronic devices, described more fully hereafter). In an alternative embodiment, the smart tags are associated with storage locations for distinct products. For example, a smart tag may be attached with the store's shelf label or other identifying indicia that indicates where particular brands and types of products are to be stored. Smart tags may be in the form of adhesive labels or the like that are attached to shelving, cabinets, refrigeration units, etc., wherever distinct products are located. In this embodiment, the scanners may be or can comprise portable hand-held devices that allow the consumer to bring the scanner within range of the affixed smart tags. Upon the consumer locating and selecting a product, the consumer would bring the scanner (or a component thereof with means for generating and receiving radiofrequency signals) near enough to the affixed smart tag to enable the scanner to excite the smart tag and subsequently retrieve the product identification information.

In a particular embodiment of the invention, the list of desired products is maintained in electronic form by the scanner (more specifically, by a processor associated with the scanner). For example, the electronic list may be separately compiled by the consumer and subsequently downloaded to the scanner. This may be accomplished by any conventional means. For example, the consumer may compile the list electronically and save the list on any suitable storage device, such as a PDA or a “smart card” with electronically entered information contained in memory. At the place of purchase of the products, the storage device may then be used to download the list to the scanner. Alternatively, the electronic list may be transmitted to the commercial place of purchase via any conventional communication system, such as e-mail, facsimile, etc., wherein the list is stored or downloaded into a scanner. Upon the consumer arriving at the place of business, the scanner is provided to the consumer. It is also within the scope and spirit of the invention to enter the list of desired products from a separately compiled paper list in a data entry step.

In another embodiment, the consumer can use a single device that permits entry of a shopping list and provides access to a database with product information associated with electronic product codes. For example, the user may use a PDA with integral means for reading RFID information and wireless access to a server that provides access to a product database.

In another embodiment, a smart tag or other identification means associated with the consumer, such as a smart tag in a driver's license or loyalty card, contains an ID code for the consumer that can be used to automatically retrieve a list stored on a secure Internet site or other source as the consumer enters a retail environment or other shopping facility. The association of a personal ID code with a list of items to obtain can be done in a manner that maintains anonymity for the consumer, if desired, such as using a chip associated with an anonymous Internet account and not associated with the consumer's actual identity, or the user can use a “smart card” that contains downloaded information not accessible to third parties. Alternatively, the retailer can offer an optional service that maintains confidentiality of consumer shopping lists and purchased items.

There are various scenarios wherein the consumers are “provided” with scanners. In one scenario, the scanners are individual devices, such as hand-held devices that may be owned or individually maintained by the consumers. For example, the consumer would merely bring the scanner with them to the market or commercial place of business. In another scenario, the scanners may be provided to customers or consumers by the commercial place of purchase. For example, a market may maintain any number of scanners that are assigned to customers as they enter the business. These scanners may be configured to accept an electronic download of the customer's list of desired products, or may be preloaded with the list, as previously mentioned. The scanners provided by the place of purchase of the products may, for example, be disposed in shopping carts or baskets used by the consumers. Alternatively, the scanners may be provided or disposed at the point of checkout. With this embodiment, the individual products would have the smart tags attached directly thereto. In any case, the consumer's current shopping list can be automatically displayed on a display device, and can show which items remain to be purchased after selected items are scanned and marked as acquired on the list. Alternatively, for vision-impaired consumers, “display” of the list and its status can comprise a tactile system such as a dynamic Braille display output device or audio signals, such as a synthesized voice which speaks the list and the status of the items. When display of information comprises an audio signal, the signal can also include spoken directions about the location of a product on the list, or an indication as to which product is closes, or a recommended optimum route for retrieving the listed items.

In an embodiment wherein the individual products at the place of purchase are each separately provided with a smart tag, the scanners may perform an “en masse” scan of the products selected by the consumer at periodic intervals or when directed by the consumer. For example, the products selected by the consumer may be stored in a shopping cart, basket, or the like. A scanner may be provided with the cart or basket, or may be a portable hand held device. The scanner is capable of exciting the totality of smart tags and retrieving all of the product information signals. The signals are decoded and annotation is correctly made on the displayed list of products if any of the scanned products are on the list of desired goods. This en masse interrogation of the selected products may be conducted at the checkout or sales counter, for example.

The scanner may also include any manner of audible or visual alarm to indicate that less than all of the products on the desired list of products have been scanned. For example, the consumer may initiate an “end” command to the scanner wherein the scanner then conducts a final tally of the selected products. If there are any products still remaining on the list of desired products, the scanner may emit an alarm or alert signal. The particular missing products may be highlighted or otherwise made known to the consumer. The scanner can also provide information for check out and billing, allowing the consumer to acquire the goods without requiring the goods to be manually scanned by a cashier. Thus, in one embodiment, the consumer places goods in a shopping cart that scans the goods as they are acquired, and when the consumer completes shopping, the consumer takes the goods out of the shopping facility, which are automatically charged to the consumer's account.

In addition to showing the consumer what products on the list have been obtained, an electronic display device can show the consumer where the products are in the store. The display device can be integral with the scanner, such as a handheld scanner with a display screen (e.g., LCD display device, plasma screen, etc.), or a separate device such as a display screen mounted to a shopping cart or a plurality of computer screens positioned at locations in a store. The displayed list can be displayed on the same display device that provides a map for the consumer or provides other information, or can be displayed on a second display device. A display device can also show price and promotional information for the products on the list, as well as suggesting alternative or associated products that may be to the consumer's advantage to purchase.

For example, if the user has “toothpaste” entered on the list, the display device showing the list can provide icons next to the word “toothpaste” on the list to show that additional information is available. A map icon can, when selected (e.g., clicked, touched in a touch-sensitive screen, etc.) provide an indication of product location (e.g., “aisle 8, front”) or a map showing where toothpaste is located in the store. The map can be a simple line drawing indicating aisles and aisle numbers, with lines and arrows showing the suggested route relative to the consumer's current position or a specified starting position. Another icon can indicate that promotional information for toothpaste is available. If selected, the consumer may then see advertisements for one or more brands of toothpaste and information on discounts available. The promotions offered may be provided to all customers seeking to purchase toothpaste, or may be targeted for a specific consumer based on purchase history information for the consumer, if available, or based on inferences regarding the list of products to be acquired and on the specific products acquired. For example, if the consumer has purchased products directed for young children, a promotion may be displayed offering a discount on children's toothpaste. Promotions can also be provided for other products not on the consumer's shopping list. For example, if the consumer has “diapers” on the list, promotions for baby food may be offered. If the toothpaste brand selected is one for wearers of dentures, an electronic coupon for vitamins marketed to senior citizens may be offered. (Paper coupons can also be printed by the scanner or other device, if desired.) Electronic coupons can be activated upon check out, and the corresponding discount applied automatically. Vendors and retailers may provide a variety of algorithms to determine what promotions are displayed for a customer, and in some cases competing vendors may use an automatic auction system to bid for the right to offer a single exclusive promotion to the consumer, typically based on the known purchase history of the consumer.

Icons or other means to access additional information can also be provided to indicate that product specifications are available. For example, in the toothpaste example, information for several brands of toothpaste can be available to allow the user to examine ingredient lists, pricing information, the presence of preservatives, artificial colors, or specified allergens, and so forth.

Maps showing the location of goods can also display a suggested route for efficient acquisition of the articles. A variety of well known algorithms can be applied to find an optimum path that reaches the various locations of products to be acquired (such algorithms are often associated with the “traveling salesman” problem in mathematics). The recommended route displayed can be continually updated based on what products have been obtained and based on the current location of the consumer. The map can also provide an estimate of the travel time remaining to complete the suggested route, the lapsed shopping time so far, and the estimated check out time.

List items should be identifiable by a computer system to relate the list to actual products in the store. If a user misspells a list item or enters an item not recognized in a database of products, a warning can be provided to allow the user to re-enter the information or select from a list of candidates, as is done, for example, in known spell-check software such as that of MicroSoft Word. Items not recognized can be manually removed from the list or maintained, and manually checked off if acquired. The user can also be prompted to select specific product choices for a generic entry (e.g., selection of a specific brand of toothpaste, optionally in association with a promotion program or a choice based on past purchases), though the user can be allowed to keep the entry generic.

In one embodiment, a “raincheck” feature can be added for cases in which a desired item is not presently available. For example, if a desired item on sale is out of stock, the consumer may scan a smart tag associated with the shelf location of the item and make an electronic raincheck request that can be accepted and honored by the store, allowing the consumer to later purchase the desired item at the sale price if purchased within a specified interval of time. The desired item and a specified quantity of the item can then be entered automatically into a shopping list for the next visit to the store. A plurality of future shopping lists can be maintained for each of a plurality of stores. Lists with raincheck items from previous visits can display the expiration date of the raincheck offer.

Future shopping lists can be created and saved for items that are not on sale as well, and for items that are in stock but not desired for purchase during the current shopping trip.

In addition to (or in place of) information provided by visual display, audio information can also be provided to the consumer. For example, the consumer may wear headphones which play messages associated with the shopping list and promotions for related goods. Audio messages can also be provided by speakers at a plurality of locations in the store, or a speaker mounted on a shopping cart or connected to the scanner. For example, the consumer may hear messages such as, “Turn left to purchase toothpaste, item 6 on your list. Larson Brand toothpaste is 20% off for you, making it just $1.55 if purchased today.” The user may select whether promotions can be played (or visually displayed), and optionally can select a desired background music or silence while shopping. Contests, sweepstakes, and general announcements can also be done via audio or readable messages.

In one embodiment, narrow beams of sound are projected to the consumer such that others do not hear the message. Hypersonics sound technology, such as that provided by American Technology (San Diego, Calif.), employs narrow ultrasonic beams that can be projected to a single user, wherein nonlinear effects can create audible sound when a human ear is in the beam path. Principles of hypersonic sound systems are described in a white paper entitled, “Theory, History, and the Advancement of Parametric Loudspeakers: A Technology Overview,” by James J. Croft and Joseph 0. Norris, Revision D, American Technology Corporation, San Diego, Calif., 2002, available at http://www.atcsd.com/pdf/HSSWHTPAPERRevD.pdf. Exemplary applications of hypersonic technology are illustrated at www.popsci.com/popsci/hometech/article/0,12543,351353,00.html.

Additional aspects of the present methodology and system will be described below with reference to the figures.

### BRIEF DESCRIPTION OF THE DRAWINGS

FIG. 1 is a graphic illustration of concepts according to a method and system of the invention.

FIG. 2 is a graphic illustration of an alternate method and system according to the invention.

FIG. 3 is a graphic illustration of yet another embodiment of the method and system according to the invention.

FIG. 4 is a graphic illustration of still another embodiment according to the invention.

### DETAILED DESCRIPTION

Reference will now be made in detail to one or more embodiments of the invention, examples of which are graphically illustrated in the drawings. Each example and embodiment are provided by way of explanation of the invention, and not meant as a limitation of the invention. For example, features illustrated or described as part of one embodiment may be utilized with another embodiment to yield still a further embodiment. It is intended that the present invention include these and other modifications and variations.

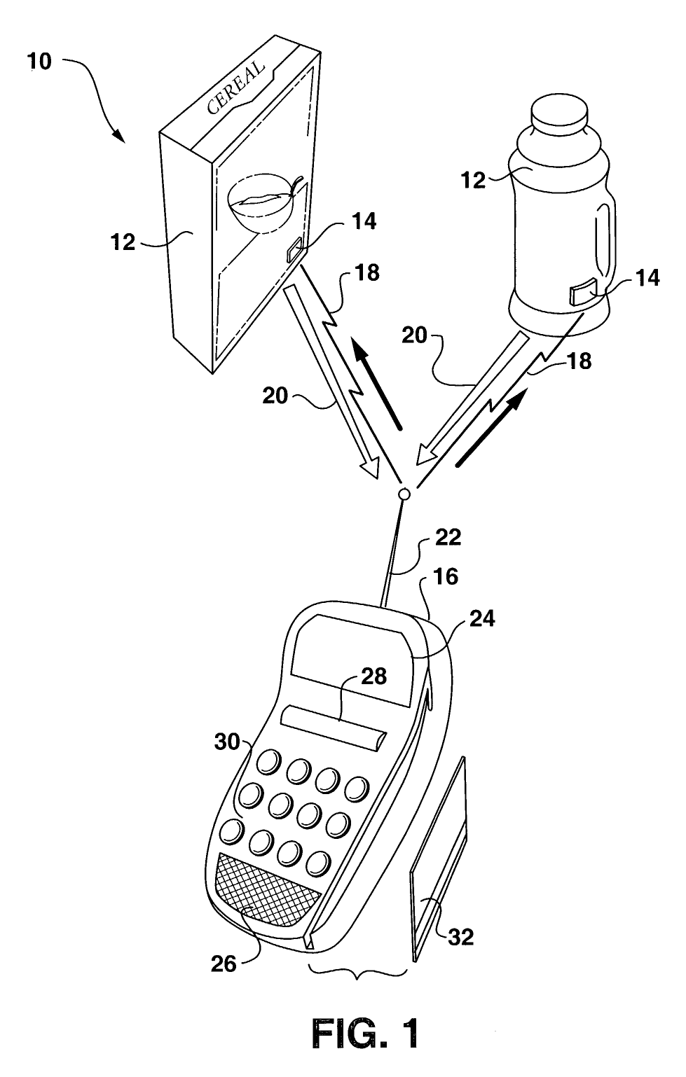

FIG. 1 graphically illustrates conceptual aspects of a method and system 10 according to the invention. The system and method is applicable for the purchase of any manner of consumer good or article from a predefined or predetermined list of desired goods. This list may be thought of as a conventional “shopping list.” In the illustrated embodiments, the products 12 are food products. It should be appreciated that this is for purposes of illustration only. The products may just as well be clothing items, hardware items, and other staple item of commerce.

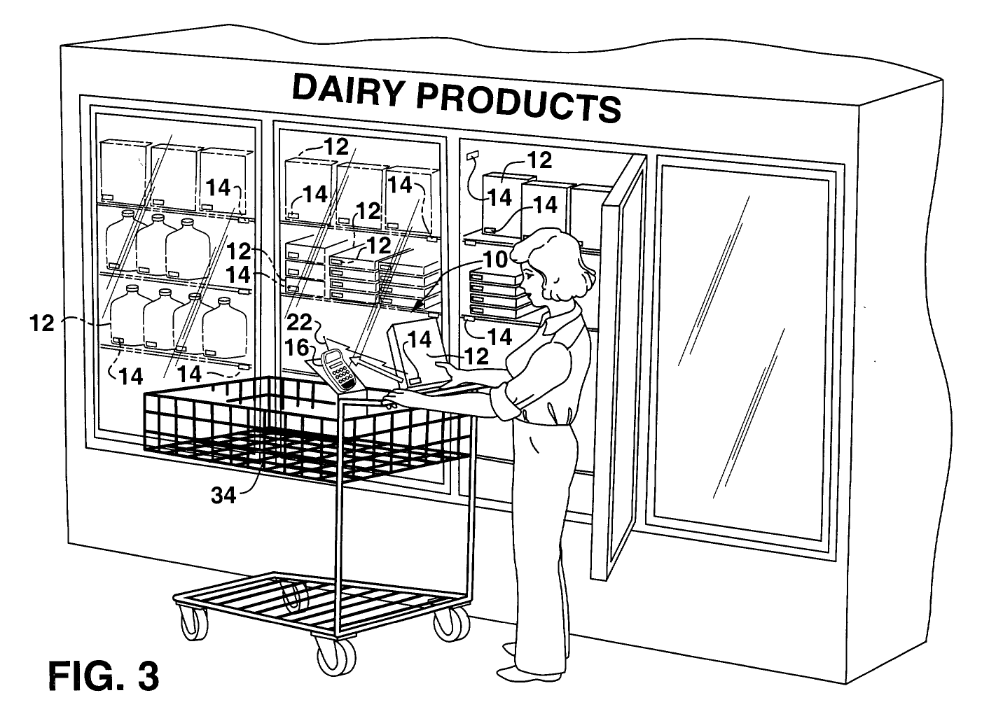

The products 12 are provided or associated with respective smart tags 14. As discussed in greater detail below, the smart tags 14 transmit a coded pulsed signal 20 containing product identification information in response to an electronic “trigger” 18 from a scanner 16. The smart tags 14 may be attached directly to the products 12, as illustrated in FIGS. 1 and 3. In this embodiment, the smart tags 14 may be, for example, adhesive backed labels or tags that are attached directly to the packaging of the products 12. In an alternative embodiment as illustrated in FIG. 3, a smart tag 14 is provided at each storage location of a different or distinct product 12. For example, the smart tags 14 may be provided on the shelves containing the products 12 along with or incorporated with the store's own identification labels. The smart tags 14 may be provided on a wall or other structure adjacent to the storage locations for the distinct products. In general, a different smart tag 14 is associated with each distinct product. For example, if the store carries three different brands of milk, then a different smart tag may be associated with each brand. Similarly, if three different size containers of the same brand of milk are carried by the store, then a different smart tag 14 may be associated with each different sized container. The system and method 10 according to the invention also includes a combination of smart tags 14 attached directly to the products and smart tags 14 disposed at the location of the products, as illustrated in FIG. 3.

The product identification information stored in the smart tags 14 is not limited in scope, and may include, for example, information identifying the type of product, brand name of product, manufacturer of the product, etc. The type of information should be adequate to correlate with various manners of listing desired products in the scanner. For example, certain consumers may only list “milk” and “butter” in a generic sense in their respective lists of desired products. Different consumers may identify the milk and butter by a particular brand name. The stored product identification information should be adequate to assimilate all reasonable conceivable methods of listing desired products.

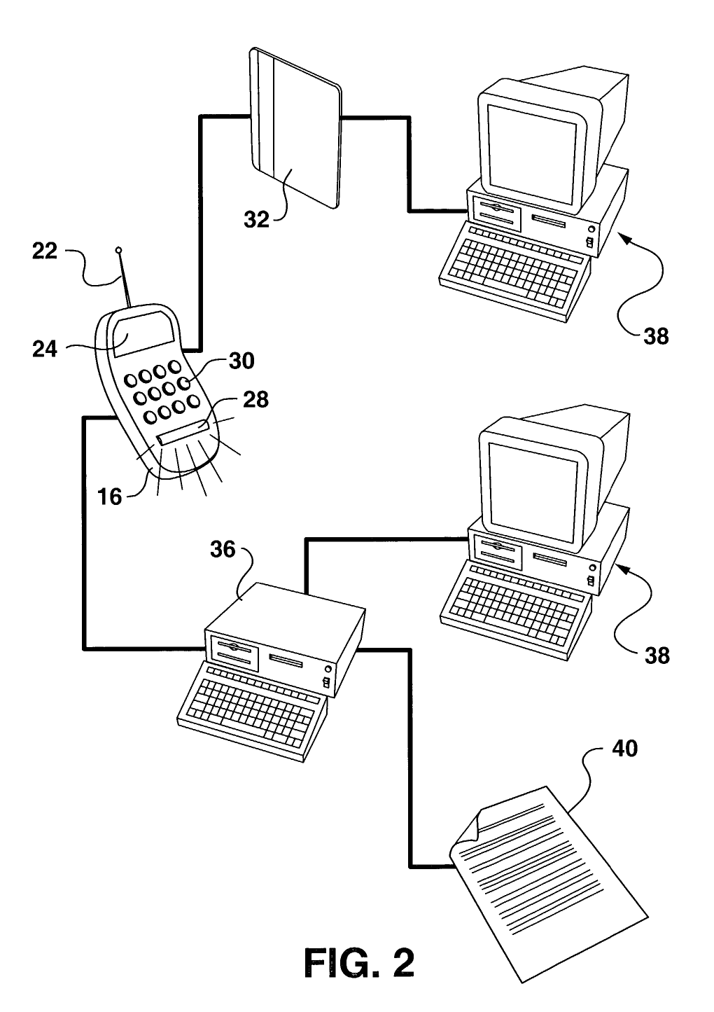

FIG. 2 graphically illustrates various ways in which a consumer's “shopping list” of products may be imported or downloaded into a RFID scanner 16. In a common scenario, consumers may keep a running printed or written list of depleted products at their home, place of business, or the like. This paper list 40 may be converted to electronic form at the place of purchase of the products by any suitable means. The commercial business may have a computer system 36 capable of scanning the list and converting the scanned items into an electronic file accepted by the scanner 16. For this purpose, the scanner 16 generally comprises a processor (not shown) for comparing the electronic list to the products acquired by the consumer and for providing other information to the consumer responsive to the electronic list or to actions of the consumer. n an alternative embodiment, the commercial business may offer data entry wherein the list is simply manually typed or inputted into the computer 36 for downloading to the scanner 16. In an alternative embodiment, the consumer may maintain the list electronically via a personal computer 38. At some point in time, the consumer may electronically transmit the list of goods to the commercial place of business via any conventional communication system, such as e-mail, facsimile, wireless system, and so forth. The commercial business then codes and downloads the list to a scanner 16 which is provided to the consumer at the time the consumer visits the commercial location. In still another embodiment, the consumer may download the list to a data storage means, such as a smart card 32. The card 32, disk, or the like, is then taken by the consumer to the commercial place of business and used to download the list to a scanner 16. In still another embodiment, the scanner 16 is personally owned or maintained by the consumer and a list of desired goods may be inputted directly into the scanner 16 by the consumer. In this case, the consumer merely takes the scanner to the place of purchase or selection of the goods. In this embodiment, the scanner 16 may be incorporated with a hand-held data entry device, such as a conventional PDA (Personal Data Assistant). It should be readily apparent that any number of scenarios for entry of a list of desired products into a RFID scanner 16 is possible in accordance with the teachings of the present invention.

With conventional RFID “smart” systems, the smart tags 14 are passive devices. The scanner 16 emits the trigger excitation signal 18 received by an internal antennae in the smart tag 14. This signal 18 causes the smart tag 14 to generate and transmit an electromagnetic pulse of coded digital data containing the product identification information signal 20. The coded signal 20 is received by the antennae 22 in the scanner 16, decoded, and the product identification information is presented to the consumer in any number of ways. For example via a visual display screen 24 incorporated with the scanner 16 or a remote video screen monitored on the shopping cart and in electronic communication (e.g., via radio signals) with the processor of the RFID scanner 16.

RFID smart tag technology is known and understood by those skilled in the art, and a detailed explanation thereof is not necessary for purposes of describing the method and system according to the present invention. Generally, conductive or passive smart tags 14 consist of silicon or other semiconductors, a coiled, etched, or stamped antennae, a capacitor, and a substrate on which the components are mounted or embedded. A protective covering is typically used to encapsulate and seal the substrate. Inductive or passive smart tags have been introduced by Motorola under the name “BiStatix”. A detailed description of the BiStatix device may be found in U.S. Pat. No. 6,259,367 B1, incorporated herein by reference in its entirety for all purposes. Another commercial source of suitable smart tags is Alien Technology Corporation of Morgan Hill, Calif., under the technology name FSA (Fluidic Self-Assembly). With the FSA process, tiny semiconductor devices are assembled into rolls of flexible plastic. The resulting “smart” substrate can be attached or embedded in a variety of surfaces. The smart tag technology under development at the Auto-ID Center at Massachusetts Institute of Technology (Cambridge, Mass.) can also be used within the scope of the present invention. Further information on smart tags and related technology is disclosed in U.S. Pat. No. 6,451,154, “RFID Manufacturing Concepts,” issued Sep. 17, 2002 to Grabau et al.; U.S. Pat. No. 6,354,493, “System and Method for Finding a Specific RFID Tagged Article Located in a Plurality of RFID Tagged Articles,” issued Mar. 12, 2002 to Mon; PCT publication WO 02/48955, published Jun. 20, 2002; U.S. Pat. No. 6,362,738, “Reader for Use in a Radio Frequency Identification System and Method,” issued Mar. 26, 2002 to Vega; D. McFarlane, “Auto-ID Based Control,” White Paper for the Auto-ID Centre Institute for Manufacturing, University of Cambridge, Cambridge, United Kingdom, Feb. 1, 2002, available at http://www.autoidcenter.org/research/CAM-AUTOID-WH004.pdf; and Chien Yaw Wong, “Integration of Auto-ID Tagging System with Holonic Manufacturing Systems,” White Paper for the Auto-ID Centre Institute for Manufacturing, University of Cambridge, Cambridge, United Kingdom, September 2001, available at www.autoidcenter.org/research/CAM-WH-001.pdf.

Other RFID technologies believed to be of value for the present invention include those produced by Microchip Technologies (Chandler, Arizona), which provides remote read-write chips at several frequencies. Also of potential value are the I*CODE chips and readers of Philips Semiconductor (Eindhoven, The Netherlands), which, in one embodiment, are said to include 384 bit configurable read/write memory with 64 bits for a unique serial number (e.g., an electronic product code). Sokymat (Lausanne, Switzerland) markets the PICCOLO read-only RFID disc tag which transmits data to a reader station by an AM radio signal. The tag is said to have 64 bits of data that can be programmed during manufacturer by laser fusing of polysilicon links in order to store a unique code on each tag.

Texas Instruments (Dallas, Tex.) offers RFID technology as part of Texas Instruments RFID (TI*RFID™) Systems, formerly known as the TIRIS© system (Texas Instruments Registration and Identification System), which is used to track and identify various assets using devices such as the TI Tag It™ chip.

Gemplus (Gemenos, France) provides smart tags (sometimes called “smart labels”) and smart cards employing RFID technology, which may be used as smart tags. They also market interfaces, antennas, scanners and software that can be adapted for use with smart tags.

Nedap (Groenlo, The Netherlands) provides smart cards and a 13.56 MHz smart tag using RFID technology with 512 bits of read-write memory with a range of about 120 cm. It is claimed that about 20 such tags per second can be read successfully by a scanner.

Checkpoint Systems Inc. (Miami, Fla.) offers a smart tag with WORM technology (write once, read many). One example is the MCRF355 chip, described more fully at http://www.idsystems.com/reader/1999_{—}05/join0599.htm.

PDA-like reader systems and other portable readers for RFID technology are marketed by Omron Company (Tokyo, Japan), such as the Model V700 or V720 series.

High frequency bands can be used in RFID technology, such as bands between 300 MHz and 10 GHz. SCS Corporation (Rancho Bernardo, Calif.), for example, markets smart tag technology at 2.45 GHz. Ultra-wide band technology can also be adapted for RFID systems. A related technology within the scope of the present invention is Surface Acoustic Wave (SAW) technology. For example, InfoRay (Cambridge, Mass.) markets a passive smart tag that is said to achieve long ranges (up to 30 meters) using a Surface Acoustic Wave (SAW) device. On a chip coupled with an antenna. The SAW device converts a radio signal to an acoustic wave, modulates it with an ID code, then transforms it to another radio signal that is emitted by the smart tag and read by a scanner. The ID code of the smart tag is extracted from the radio signal. The scanner is said to compare the spectral content of the signal with a database of signatures and to derive the ID code. This method enables a read range of up to 30 m (typical 10-20 m). The system can operate in the 915 MHz band and 2.45 GHz band. RFSAW, Inc. (Dallas, Tex.) also provides minute Surface Acoustic Wave (SAW) RFID devices that can be used within the scope of the present invention.

The antennae embedded within the smart tags 14 is generally one component of the device, though it is recognized that alternatives to antennas may exist in some applications. (For example, for some metallic objects, the smart tag need not comprise an antenna but the metallic object itself can serve as the antenna.) The excitation signal 18 from the scanner 16 can be be received by the antennae to “activate” the smart tag. The received excitation signal 18 is the power source for the smart tag 14 and results in the generation of the electromagnetic pulse containing the coded product identification information signal 20. A detailed description of RFID smart tag antennas may be found in U.S. Pat. No. 6,320,556 B1, incorporated herein by reference for all purposes.

In an alternate embodiment, the smart tags 14 may be active devices. In this configuration, the smart tag 14 includes active transceiving circuitry that has the capability to selectively respond to coded request signals transmitted by a scanner 16. The active smart tag 14 may include the capability to delete their fixed code and receive new or additional information beyond the information contained in its fixed code. An active smart tag 14 requires an internal power supply, such as a micro-battery, thin film battery, or the like. Active tags 14 may be desired in the scenarios wherein the tags 14 are mounted at storage locations of particular products. In this way, as different products are stored at the respective locations, the smart tags 14 can be programmed accordingly.

The RFID scanner 16 may be of conventional hardware and software architecture. The scanner 16 receives and may display the consumer's list of desired products via a display screen 24. While the scanner 16 is portrayed as having a built-in visual display screen 24, it is recognized that the RFID scanner can comprise a plurality of physically separated but cooperatively associated electronic devices that are not shown independently such as a radiofrequency signal generator and receiver, the processor, one or more display means such as a visual display screen 24, a magnetic card reader, an audio speaker, and the like, each communicating with or under control of the processor of the RFID scanner 16. Upon a product being brought into range of the scanner 16, the respective smart tag 14 is triggered and the coded product identification signal 20 is received by the scanner and decoded into usable commands or data. The scanner 16 includes a microprocessor and software programs for this purpose. The scanner determines if the scanned product is on the list of desired products and, if so, automatically annotates the list in a way visible to the consumer to indicate that the product is accounted for. For example, the product may be removed from the displayed list, highlighted on the list, and so forth.

The scanner 16 may incorporate an alarm or alert feature wherein the consumer is notified if less than all of the products on the list of desired goods have been scanned. For example, the consumer may enter an “end” command to the scanner 16 whereby the scanner 16 then conducts a final tally for comparison of actual scanned items against the list of desired products. If a product is missing, the scanner may incorporate an audible alarm 26 or visual alarm 28 to indicate such to the consumer. The missing product may be highlighted or otherwise made known to the consumer.

FIG. 3 graphically illustrates a typical market scenario. In this embodiment, the system 10 includes products 12 with smart tags 14 attached directly thereto or provided on the store shelves, within the refrigeration units, etc., at locations adjacent to the distinct products 12. A shopping cart 34, or any other basket or device used by the consumer to gather products is provided with a scanner 16 with a display device mounted for easy viewing and access by the consumer. The scanner 16 may be provided by the commercial establishment, or may be the consumer's personal device, as discussed above. With this arrangement, the consumer may select a product 12 and scan the product 12 by bringing it within relatively close proximity to the scanner 16. The scanner 16 may give an immediate indication to the consumer to indicate that the product was recognized. Alternatively, in the embodiment wherein the scanner 16 is a handheld device, the consumer may scan the smart tag 14 disposed at the product location upon selecting a particular product. A option can also be provided for deleting an object from the list of scanned objects in the event the consumer decides to not purchase the product 12 after all.

In the embodiment wherein the distinct products 12 are provided with individual smart tags 14, the scanner may conduct a periodic en masse interrogation of collected products 12. For example, a number of products 12 may be collected in the basket 34 and the consumer may simply instruct the scanner 16 to conduct an en masse interrogation of the products. This feature may be desirable to consumers who tend to shop, for example, from aisle to aisle in a market without seeking out individual items listed on a shopping list.

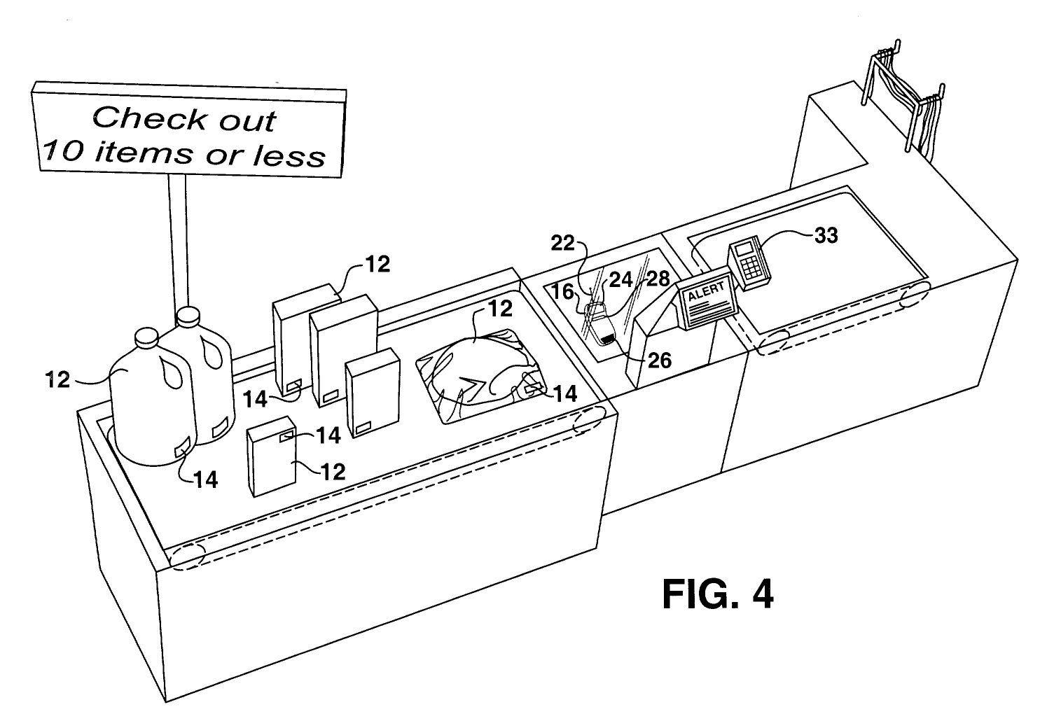

FIG. 4 conceptually illustrates an alternative market scenario wherein the scanner 16 is provided at a point of checkout, such as at the sales register. As the products 12 are conveyed past the scanner 16, the product identification information is displayed to the consumer. The scanner 16 may be incorporated with the conventional bar code scanning system used at the checkout counter. In this particular embodiment, the consumer may swipe a smart card 32 containing their shopping list through a smart card reader 33 interfaced with the scanner 16. This checkout system embodiment of the invention may serve as a final point of accountability for the consumer to ensure that all desired products have been purchased prior to leaving the store.

It should be appreciated that the scanner 16 can be configured to accommodate consumers having visual impairment, language difficulties, illiteracy, etc. For example, the scanners may be configured with a visual display 24 that conveys the food product information in different languages or pictorially. The scanner 16 may emit voice messages in selected foreign languages. Various configurations of the scanner 16 in this regard are within the scope and spirit of the invention.

It should also be appreciated that the system and method according to the invention are not limited to any particular type of commercial or market scenario, but have application wherever consumer goods or products are typically purchased in accordance with a predefined or predetermined list of such products.

It should be appreciated by those skilled in the art that the system and method according to the invention have wide applications, and that the example and embodiments set forth herein are merely exemplary. It is intended that the present invention include such uses and embodiments as come within the scope and spirit of the appended claims.

What is claimed is:

1. A method for aiding consumers in the selection or purchase of products according to a predetermined list of such products, said method comprising:
associating RFID smart tags with products, wherein each distinct product is associated with at least one smart tag, the smart tags containing identification information regarding their respective product;
entering a list of desired products into a RFID scanner;
displaying the list of desired products to the consumer such that the consumer may locate and select the desired products;
scanning the smart tags associated with the selected products with the scanner such that the scanner retrieves the product identification information; and
in response to the scanned and identified product, automatically updating the list of desired products to indicate that a particular product has been acquired.

2. The method as in claim 1, wherein the smart tags are attached to the products, the individual products being scanned by the scanner.

3. The method as in claim 1, wherein the smart tags are associated with storage locations of the distinct products, the scanner comprising a hand-held device that scans the location smart tag.

4. The method as in claim 1, wherein the list of desired products is an electronic list that is electronically entered into the scanner.

5. The method as in claim 4, wherein the electronic list is generated by the consumer.

6. The method as in claim 5, wherein the consumer enters the electronic list into the scanner.

7. The method as in claim 6, wherein the scanner comprises a portable hand-held device that stores the list in memory.

8. The method as in claim 7, wherein the scanner is owned or maintained by the consumer and brought by the consumer to the place of purchase or selection of the products.

9. The method as in claim 1, wherein consumers are provided with individual personal scanners at the place of purchase or selection of the products.

10. The method as in claim 9, wherein the consumer enters the list of products into the scanner provided at the place of purchase or selection of the products.

11. The method as in claim 10, wherein the individual scanners are portable hand-held units.

12. The method as in claim 10, wherein the list of products is entered into the individual scanners by the place of purchase or selection of the products from a list previously received from the consumer.

13. The method as in claim 12, wherein the consumer electronically transmits the list of products to the place of purchase or selection of the products.

14. The method as in claim 9, wherein the scanners are provided in carts or baskets supplied by the place of purchase or selection of the products.

15. The method as in claim 1, wherein the scanner provides an alarm in the event that less than all of the products on the list of products have been scanned.

16. The method as in claim 1, wherein the products have individual smart tags associated therewith, and the selected products are scanned en masse by the scanner.

17. The method as in claim 16, wherein the selected products are scanned en masse at a point of check-out from the place of purchase or selection of the products.

18. The method as in claim 1, further comprising electronically indicating the location of one or more products.

19. The method as in claim 18, wherein the one or more products are located in a shopping facility, and further comprising electronically indicating a recommended route in the shopping facility for efficiently acquiring the one or more products.

20. The method as in claim 18, wherein a map of the shopping facility is displayed to the consumer with indicia on the map showing the location of the one or more products.

21. The method as in claim 1, further comprising automatically providing promotional information to the consumer for one or more products on the list of desired products.

22. The method as in claim 21, wherein visual display means or audio means associated with the scanner provides the promotional information to the consumer.

23. The method as in claim 21, wherein the promotional information is targeted to the consumer responsive to the consumer's previous purchase history.

24. The method as in claim 1, further comprising automatically providing promotional information to the consumer via the scanner or a device cooperatively associated with the scanner for one or more products related to at least one product on the list of desired products.

25. The method as in claim 1, further comprising automatically charging the consumer for the selected products without the need for a cashier to manually scan the selected products.

26. The method as in claim 1, wherein displaying the list of desired products to the consumer comprises providing a visible display on a display device.

27. The method as in claim 1, wherein displaying the list of desired products to the consumer comprises providing an audio signal that is audible to the consumer.

28. The method as in claim 27, wherein providing an audio signal comprises generating a hypersonic signal.

29. A RFID system for aiding consumers in the selection or purchase of products according to a predetermined list of such products, said system comprising:
RFID smart tags associated with products at a place of purchase or selection of such products, wherein each distinct product is associated with at least one said smart tag, said smart tags containing identification information regarding their respective product;
a RFID scanner accessible to a consumer at the place of purchase or sale of the products, the RFID scanner comprising means for retrieving said product identification information from said smart tags upon the products being selected by a consumer, a processor for receiving a list of desired products and comparing the list of desired products to products selected by a consumer, and display means for displaying the list of desired products,
wherein said scanner automatically notates on said displayed list on the display means that a particular product on said list has been accounted for.

30. The system as in claim 29, wherein said smart tags are attached to the products.

31. The system as in claim 29, wherein said smart tags are disposed at storage locations of the distinct products, said scanner being a hand-held device that scans said smart tags at their respective product locations.

32. The system as in claim 29, wherein said list of desired products is an electronic list, said scanner configured for receipt of said electronic list.

33. The system as in claim 29, wherein said scanner is disposed in a cart or basket at the place of purchase or selection of the products.

34. The system as in claim 29, wherein said scanner comprises an alarm in the event that less than all of the products on said list of products have been scanned.

35. The system as in claim 29, wherein method as in claim 16, wherein the selected products are scanned en masse at a point of check-out from the place of purchase or selection of the products.

36. The system as in claim 29, wherein said scanner is disposed at a point of check-out in the place of purchase or selection of the products.

37. The system as in claim 29, wherein said display means comprises an output screen for visible display.

38. The system as in claim 29, wherein said display means comprises an audio system for generating audible signals.
